(19) United States
(12) Patent Application Publication
(10) Pub. No.: US 2026/0303496 A1
(43) Pub. Date: Oct. 1, 2026

(54) STEERING MODE FOR ACCESS NETWORK SELECTION

(71) Applicant: QUALCOMM Incorporated, San Diego, CA (US)

(72) Inventors: Olufunmilola Omolade AWONIYI-OTERI, San Diego, CA (US); Dario Serafino TONESI, San Diego, CA (US)

(21) Appl. No.: 19/094,620

(22) Filed: Mar. 28, 2025

(51) Int. Cl. H04L 43/0805; H04L 5/00; H04L 65/1069

(52) U.S. Cl. CPC H04L 43/0805; H04L 5/0044; H04L 65/1069

(57) ABSTRACT

Various aspects of the present disclosure generally relate to wireless communication. In some aspects, a user equipment (UE) may receive, from a first network entity, a set of rules associated with a steering mode for access network (AN) selection in accordance with an energy usage metric and a quality of service (QoS) metric associated with communication with a second network entity via at least one AN. The UE may transmit, via the at least one AN selected in accordance with the set of rules, an uplink communication to the second network entity. The UE may receive, via the at least one AN selected in accordance with the set of rules, a downlink communication from the second network entity. Numerous other aspects are described.

### FIELD OF THE DISCLOSURE

Aspects of the present disclosure generally relate to wireless communication and specifically relate to techniques, apparatuses, and methods associated with a steering mode for access network selection.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple radio access technologies (RATs) devices capable of supporting communication with a network via multiple RATs. Such multiple RATs devices are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). Other examples of RATs include LTE or Wi-Fi, the latter of which are considered to be non-3GPP access. In addition, network devices can access wireless communication systems also via wired access. As the demand for connectivity continues to increase, further improvements in NR may be implemented, and other RATs, such as those for 6G and beyond, may be introduced to enable new applications and facilitate new use cases.

When a network device supports multiple network access options, the network device performs an access selection process. The access selection process may allow the network device to select one or more access networks (ANs), from among multiple ANs, for data transmissions.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a first network entity, a set of rules associated with a steering mode for access network (AN) selection in accordance with an energy usage metric and a quality of service (QoS) metric associated with communication with a second network entity via at least one AN. The processing system may be configured to cause the UE to transmit, via the at least one AN selected in accordance with the set of rules, an uplink communication to the UPF. The processing system may be configured to cause the UE to receive, via the at least one AN selected in accordance with the set of rules, a downlink communication from the UPF.

Some aspects described herein relate to a UPF. The user plane function may include a processing system. The processing system may include one or more processors and one or more code-storing memories coupled with the one or more processors. The processing system may be configured to cause the UPF to receive, from a SMF, a set of rules associated with a steering mode for AN selection in accordance with an energy usage metric and a QoS metric associated with communication with a UE via at least one AN. The processing system may be configured to cause the UPF to receive, via the at least one AN selected in accordance with the set of rules, an uplink communication from the UE. The processing system may be configured to cause the UPF to transmit, via the at least one AN selected in accordance with the set of rules, a downlink communication to the UE.

Some aspects described herein relate to a SMF. The session management function may include a processing system. The processing system may include one or more processors and one or more code-storing memories coupled with the one or more processors. The processing system may be configured to cause the SMF to transmit, to a UE, a first set of rules associated with a steering mode for AN selection in accordance with an energy usage metric and a QoS metric. The processing system may be configured to cause the SMF to transmit, to a UPF, a second set of rules associated with the steering mode for AN selection in accordance with the energy usage metric and the QoS metric.

Some aspects described herein relate to a method of wireless communication performed by a UE. The method may include receiving, from a SMF, a set of rules associated with a steering mode for AN selection in accordance with an energy usage metric and a QoS metric associated with communication with a UPF via at least one AN. The method may include transmitting, via the at least one AN selected in accordance with the set of rules, an uplink communication to the UPF. The method may include receiving, via the at least one AN selected in accordance with the set of rules, a downlink communication from the UPF.

Some aspects described herein relate to a method of wireless communication performed by a UPF. The method may include receiving, from a SMF, a set of rules associated with a steering mode for AN selection in accordance with an energy usage metric and a QoS metric associated with communication with a UE via at least one AN. The method may include receiving, via the at least one AN selected in accordance with the set of rules, an uplink communication from the UE. The method may include transmitting, via the at least one AN selected in accordance with the set of rules, a downlink communication to the UE.

Some aspects described herein relate to a method of wireless communication performed by a SMF. The method may include transmitting, to a UE, a first set of rules associated with a steering mode for AN selection in accordance with an energy usage metric and a QoS metric. The method may include transmitting, to a UPF, a second set of rules associated with the steering mode for AN selection in accordance with the energy usage metric and the QoS metric.

Some aspects described herein relate to a non-transitory computer-readable medium that stores a set of instructions for wireless communication by a UE. The set of instructions, when executed by one or more processors of the UE, may cause the UE to receive, from a SMF, a set of rules associated with a steering mode for AN selection in accordance with an energy usage metric and a QoS metric associated with communication with a UPF via at least one AN. The set of instructions, when executed by one or more processors of the UE, may cause the UE to transmit, via the at least one AN selected in accordance with the set of rules, an uplink communication to the UPF. The set of instructions, when executed by one or more processors of the UE, may cause the UE to receive, via the at least one AN selected in accordance with the set of rules, a downlink communication from the UPF.

Some aspects described herein relate to a non-transitory computer-readable medium that stores a set of instructions for wireless communication by a UPF. The set of instructions, when executed by one or more processors of the UPF, may cause the UPF to receive, from a SMF, a set of rules associated with a steering mode for AN selection in accordance with an energy usage metric and a QoS metric associated with communication with a UE via at least one AN. The set of instructions, when executed by one or more processors of the UPF, may cause the UPF to receive, via the at least one AN selected in accordance with the set of rules, an uplink communication from the UE. The set of instructions, when executed by one or more processors of the UPF, may cause the UPF to transmit, via the at least one AN selected in accordance with the set of rules, a downlink communication to the UE.

Some aspects described herein relate to a non-transitory computer-readable medium that stores a set of instructions for wireless communication by an one or more instructions that, when executed by one or more processors of an SMF. The set of instructions, when executed by one or more processors of the one or more instructions that, when executed by one or more processors of an SMF, may cause the one or more instructions that, when executed by one or more processors of an SMF to transmit, to a UE, a first set of rules associated with a steering mode for AN selection in accordance with an energy usage metric and a QoS metric. The set of instructions, when executed by one or more processors of the one or more instructions that, when executed by one or more processors of an SMF, may cause the one or more instructions that, when executed by one or more processors of an SMF to transmit, to a UPF, a second set of rules associated with the steering mode for AN selection in accordance with the energy usage metric and the QoS metric.

Some aspects described herein relate to an apparatus for wireless communication. The apparatus may include means for receiving, from a SMF, a set of rules associated with a steering mode for AN selection in accordance with an energy usage metric and a QoS metric associated with communication with a UPF via at least one AN. The apparatus may include means for transmitting, via the at least one AN selected in accordance with the set of rules, an uplink communication to the UPF. The apparatus may include means for receiving, via the at least one AN selected in accordance with the set of rules, a downlink communication from the UPF.

Some aspects described herein relate to an apparatus for wireless communication. The apparatus may include means for receiving, from a SMF, a set of rules associated with a steering mode for AN selection in accordance with an energy usage metric and a QoS metric associated with communication with a UE via at least one AN. The apparatus may include means for receiving, via the at least one AN selected in accordance with the set of rules, an uplink communication from the UE. The apparatus may include means for transmitting, via the at least one AN selected in accordance with the set of rules, a downlink communication to the UE.

Some aspects described herein relate to an apparatus for wireless communication. The apparatus may include means for transmitting, to a UE, a first set of rules associated with a steering mode for AN selection in accordance with an energy usage metric and a QoS metric. The apparatus may include means for transmitting, to a UPF, a second set of rules associated with the steering mode for AN selection in accordance with the energy usage metric and the QoS metric.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example associated with a steering mode for radio access network (RAN) selection.

FIG. 3 is a diagram illustrating an example associated with access selection criteria based on an energy usage threshold.

FIG. 4 is a diagram illustrating an example associated with access selection criteria in accordance with a schedule.

FIG. 5 is a diagram illustrating an example associated with access selection criteria in accordance with percentages of time in a time window.

FIGS. 6-9 are a diagram illustrating examples associated with a steering mode for access network selection.

FIG. 10 is a diagram illustrating an example process performed, for example, at a user equipment (UE) or an apparatus of a UE.

FIG. 11 is a diagram illustrating an example process performed, for example, at a user plane function (UPF) or an apparatus of a UPF.

FIG. 12 is a diagram illustrating an example process performed, for example, at a session management function (SMF) or an apparatus of an SMF.

FIGS. 13-15 are a diagrams of example apparatuses for wireless communication.

### DETAILED DESCRIPTION

In some wireless networks, network access for traffic steering, switching, and splitting (ATSSS) rules allow a wireless communication device, such as a user equipment (UE), to select an access network (AN) from among multiple ANs. The ATSSS process enables multiple access (MA) protocol data unit (PDU) sessions by allowing traffic to be steered over different access links. MA rules (MARs) may allow a network entity, such as a user plane function (UPF), to steer traffic across different RANs. The ATSSS rules and the MAR rules may be communicated from a network entity, such as a session management function (SMF). For example, the SMF may communicate the MAR rules to the UPF via an N4 interface. The SMF may communicate the ATSSS rules with a UE via an access and mobility management function (AMF). For example, the SMF may provide the ATSSS rules to the AMF via an N11 interface, and the AMF may provide the ATSSS rules to the UE via an N1 interface.

ATSSS rules and MAR rules typically require the UE and the UPF to select RANs in accordance with quality of service (QoS)-based criteria, such as round-trip time (RTT) and packet loss rate (PLR). Satisfying the QoS criteria, however, can result in significant energy expenditure by the UE, the UPF, or both. Focusing ATSSS rules and MAR rules solely on energy usage criteria can result in poor QoS. Legacy ATSSS rules and legacy MAR rules do not permit the UE and UPF, respectively, to balance QoS criteria with energy usage criteria when performing an AN selection process. Additionally, legacy ATSSS rules and MAR rules do not permit the UE and UPF to coordinate the criteria used for AN selection. This can lead to inconsistent AN selection choices and, consequently, suboptimal network performance.

Various aspects relate generally to AN selection in accordance with QoS criteria and energy usage criteria. Some aspects more specifically relate to an SMF providing a UE and a UPF with a set of rules for a steering mode for AN selection. For example, the UE may receive a first set of rules associated with the steering mode, and the set of rules may include criteria based on an energy usage metric and a QoS metric. Alternatively or in addition, the UPF may receive, from the SMF, a second set of rules associated with the steering mode, and the set of rules received at the UPF may also include criteria based on the energy usage metric and the QoS metric. The UE and UPF may communicate with one another via at least one AN selected in accordance with the sets of rules for the steering mode provided by the SMF.

Particular aspects of the subject matter described in this disclosure can be implemented to realize one or more of the following technical benefits. By accounting for energy metrics and QoS metrics in the ATSSS rules and MAR rules, the described techniques enable a more efficient allocation of network resources, which can reduce overall energy consumption and network congestion. This may result in a more sustainable network operation that conserves energy resources and processing resources by optimizing the AN selection based on real-time energy and quality metrics. Additionally, in some aspects, the sets of rules may facilitate dynamic adjustments to AN selection based on a schedule or percentage of time window, which allows the network to strategically balance energy consumption against QoS demands. This may enhance network flexibility and improve the efficient use of network and radio resources. In some aspects, the SMF may coordinate the decision-making process between the UE and UPF, which may result in consistent and energy-efficient AN selection. By designating a primary entity for decision-making, the disclosed techniques may prevent or minimize resource-intensive conflicts and optimize network performance, thereby conserving network resources and reducing unnecessary energy expenditure.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

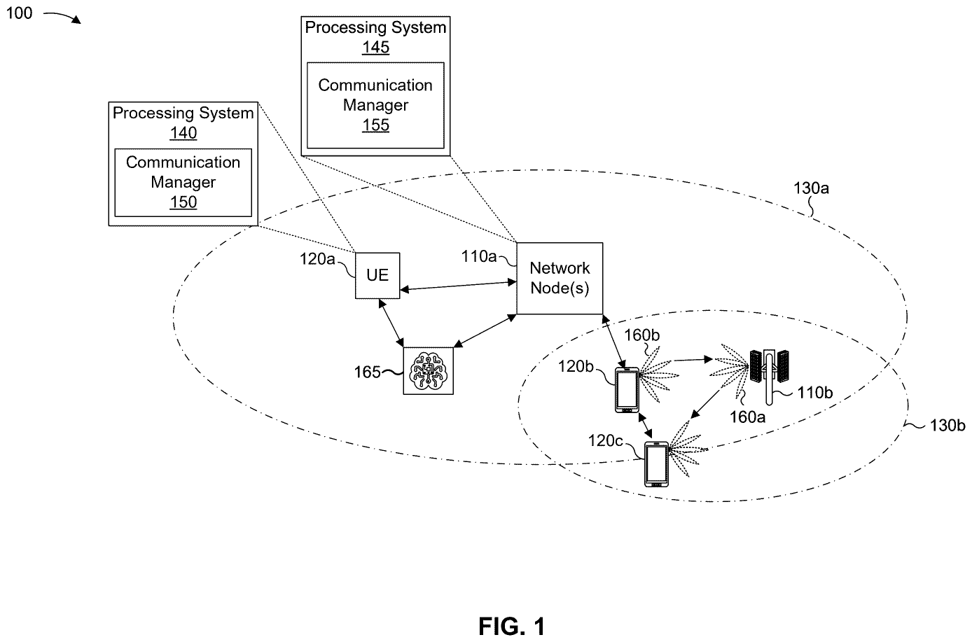

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a first network entity (e.g., an SMF), a set of rules associated with a steering mode for AN selection in accordance with an energy usage metric and a QoS metric associated with communication with a second network entity (e.g., a UPF) via at least one AN; transmit, via the at least one AN selected in accordance with the set of rules, an uplink communication to the second network entity; and receive, via the at least one AN selected in accordance with the set of rules, a downlink communication from the second network entity. Additionally, or alternatively, the communication manager 150 may perform one or more other operations described herein.

In some aspects, the UPF may include a communication manager (e.g., communication manager 155). As described in more detail elsewhere herein, the communication manager of the UPF may receive, from a network entity (e.g., an SMF), a set of rules associated with a steering mode for AN selection in accordance with an energy usage metric and a QoS metric associated with communication with a UE via at least one AN; receive, via the at least one AN selected in accordance with the set of rules, an uplink communication from the UE; and transmit, via the at least one AN selected in accordance with the set of rules, a downlink communication to the UE. Additionally, or alternatively, the communication manager may perform one or more other operations described herein.

In some aspects, the SMF may include a communication manager (e.g., communication manager 155). As described in more detail elsewhere herein, the communication manager may transmit, to a UE, a first set of rules associated with a steering mode for AN selection in accordance with an energy usage metric and a QoS metric; and transmit, to a network entity (e.g., a UPF), a second set of rules associated with the steering mode for AN selection in accordance with the energy usage metric and the QoS metric. Additionally, or alternatively, the communication manager may perform one or more other operations described herein.

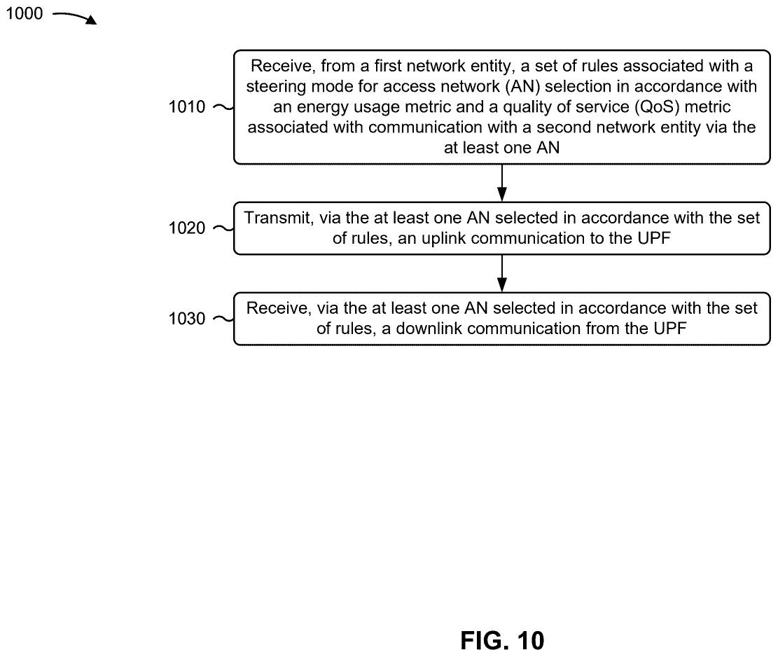

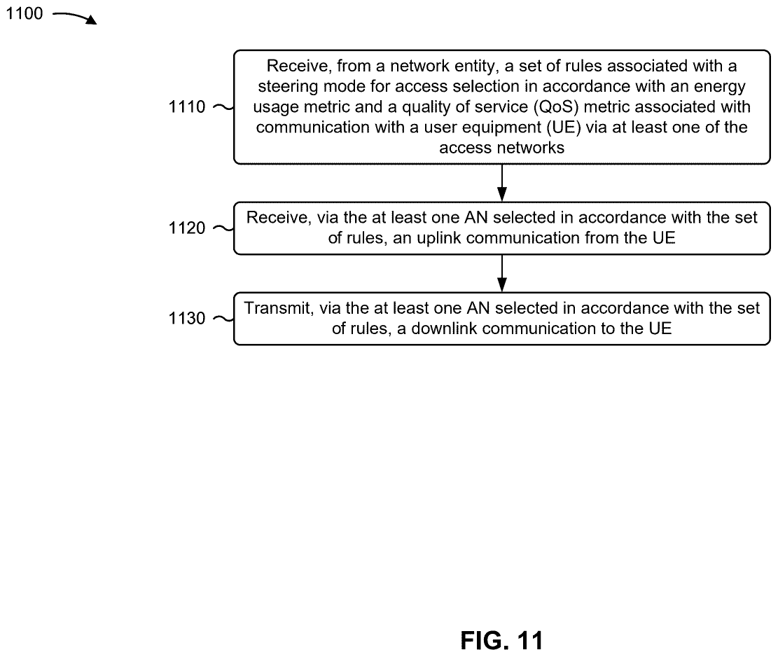

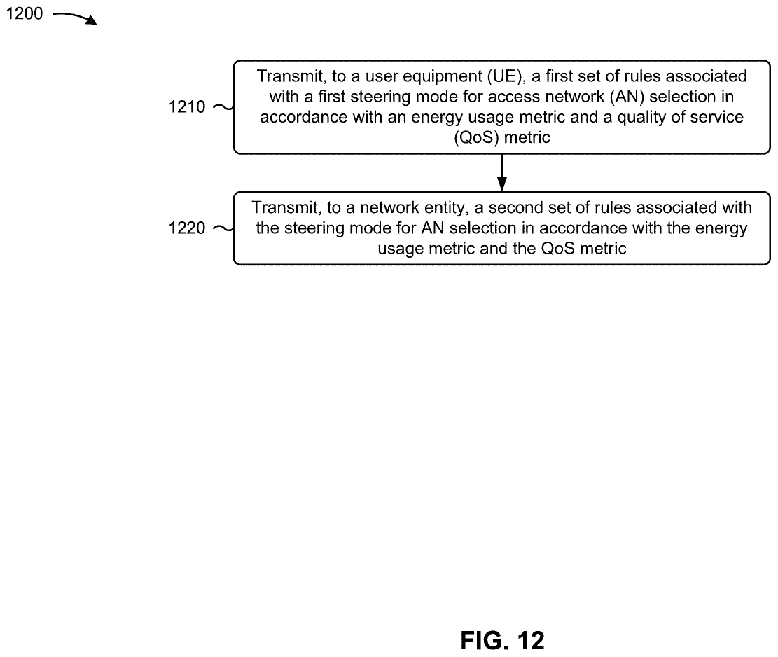

The network node 110, the processing system 145 of the network node 110, the UE 120, the processing system 140 of the UE 120, or any other component(s) of FIG. 1 may implement one or more techniques or perform one or more operations associated with a steering mode for AN selection, as described in more detail elsewhere herein. For example, the processing system 145 of the network node 110 or the processing system 140 of the UE 120 may perform or direct operations of, for example, process 1000 of FIG. 10, process 1100 of FIG. 11, process 1200 of FIG. 12, or other processes as described herein (alone or in conjunction with one or more other processors). In some aspects, the SMF or UPF described herein is the network node 110, is included in the network node 110, or includes one or more components of the network node 110 shown in FIG. 1. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 1000 of FIG. 10, process 1100 of FIG. 11, process 1200 of FIG. 12, or other processes as described herein. In some examples, executing instructions may include running the instructions, converting the instructions, compiling the instructions, or interpreting the instructions, among other examples.

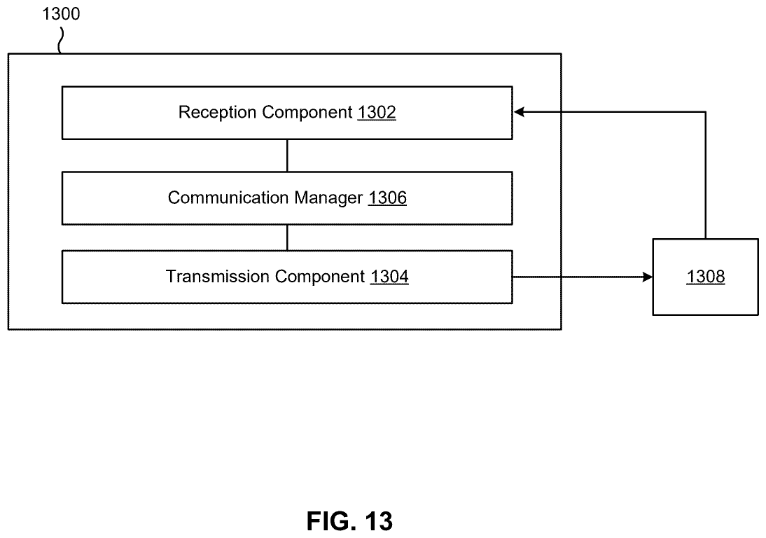

In some aspects, the UE includes means for receiving, from a first network entity (e.g., an SMF), a set of rules associated with a steering mode for AN selection in accordance with an energy usage metric and a QoS metric associated with communication with a second network entity (e.g., a UPF) via at least one AN; means for transmitting, via the at least one AN selected in accordance with the set of rules, an uplink communication to the UPF; or means for receiving, via the at least one AN selected in accordance with the set of rules, a downlink communication from the UPF. The means for the UE to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

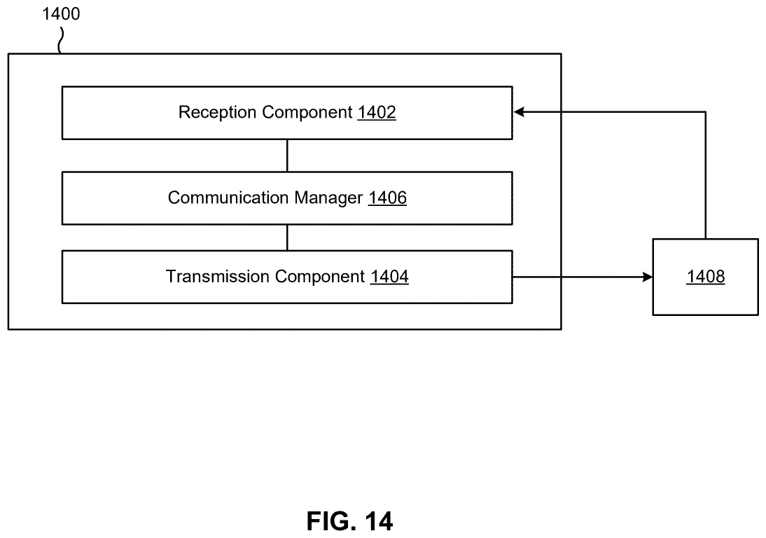

In some aspects, the UPF includes means for receiving, from a network entity (e.g., via an SMF), a set of rules associated with a steering mode for AN selection in accordance with an energy usage metric and a QoS metric associated with communication with a UE via at least one AN; means for receiving, via the at least one AN selected in accordance with the set of rules, an uplink communication from the UE; or means for transmitting, via the at least one AN selected in accordance with the set of rules, a downlink communication to the UE. In some aspects, the means for the UPF to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples. In some aspects, the means for the UPF to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

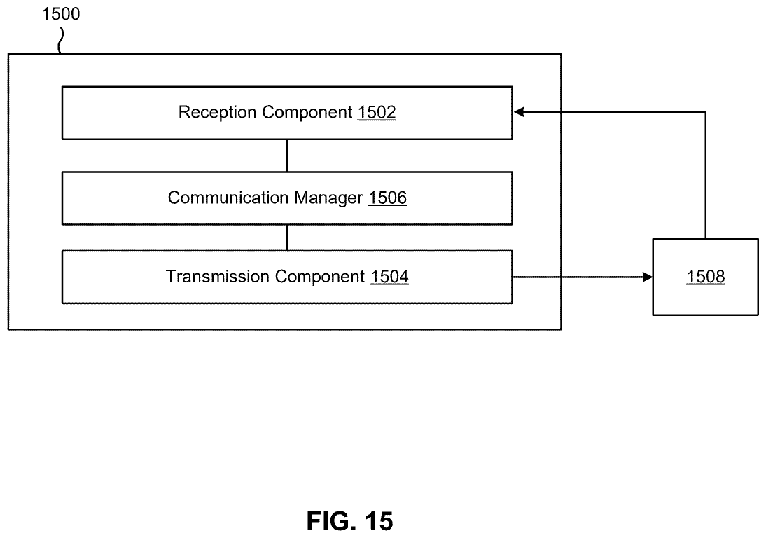

In some aspects, the SMF includes means for transmitting, to a UE, a first set of rules associated with a steering mode for AN selection in accordance with an energy usage metric and a QoS metric; or means for transmitting, to a network entity (e.g., a UPF), a second set of rules associated with the steering mode for AN selection in accordance with the energy usage metric and the QoS metric. In some aspects, the means for the SMF to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples. In some aspects, the means for the SMF to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

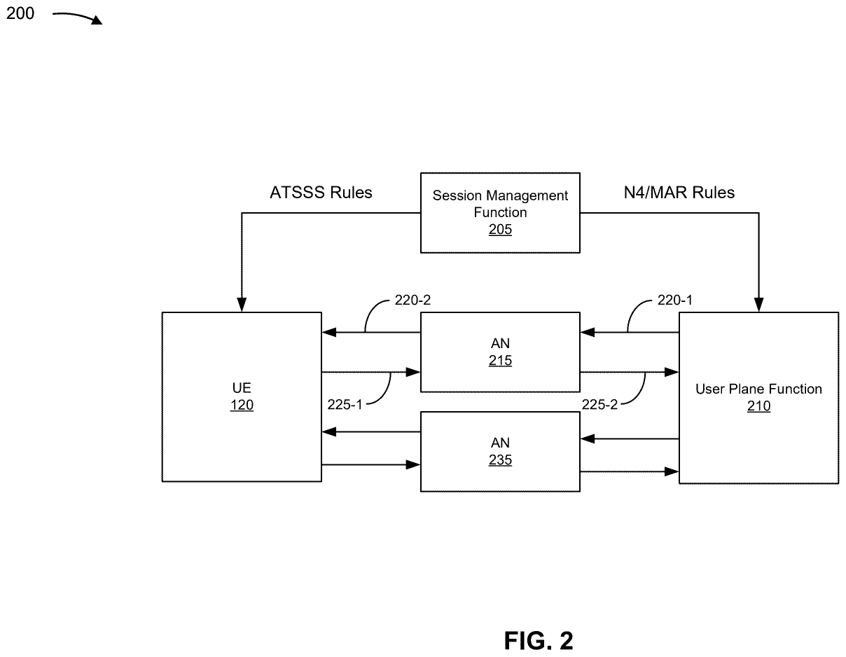

FIG. 2 is a diagram illustrating an example 200 associated with a steering mode for AN selection. As shown in FIG. 2, example 200 includes communication between an SMF 205, a UPF 210, and a UE 120.

In some aspects, the SMF 205 may transmit, to the UE 120, a first set of rules associated with a steering mode for AN selection in accordance with an energy usage metric and a QoS metric. For example, the SMF 205 may transmit the first set of rules including criteria based on the energy usage metric and the QoS metric to the UE 120. The energy usage metric may be associated with an amount of energy consumption of the UE 120 or an energy cost, while the QoS metric may be associated with the communication quality, such as RTT or PLR.

In some aspects, the SMF 205 may transmit, to a UPF 210, a second set of rules associated with the steering mode for AN selection in accordance with the energy usage metric and the QoS metric. For example, the SMF 205 may transmit the second set of rules including criteria based on the energy usage metric and the QoS metric to the UPF 210. The UPF 210 may use the second set of rules to select at least one appropriate AN 215, 235 for communication with the UE 120.

The UE 120 may receive, via the at least one AN 215 or 235 selected in accordance with the set of rules, a downlink communication 220 from the UPF 210. In some aspects, such as when the AN 215 is selected, the downlink communication 220 may include a first downlink communication 220-1 transmitted from the UPF 210 to the AN 215 and second downlink communication 220-2 from the AN 215 to the UE 120. The UE 120 may transmit, via the AN 215 selected in accordance with the set of rules, an uplink communication 225 to the UPF 210. The uplink communication 225 may include a first uplink communication 225-1 from the UE 120 to the AN 215 and a second uplink communication 225-2 from the AN 215 to the UPF 210. The selection of the AN 215 may be based on the criteria specified in the rules provided by the SMF 205, which may balance energy usage and QoS to optimize communication.

In some aspects, the UPF 210 may use the rules provided by the SMF 205 to determine the best AN 215, 235 for efficient communication with the UE 120, taking into account both energy usage and QoS metrics. Additionally, or alternatively, the selection process for the at least one AN 215, 235 may involve the UE 120 evaluating the energy usage metric and the QoS metric specified in the rules from the SMF 205 to improve communication performance. Additionally, or alternatively, in some aspects, the SMF 205 may dynamically adjust the rules based on real-time energy usage and QoS data, transmitting updated rules to both the UE 120 and the UPF 210 to maintain improved AN selection.

In some aspects, the energy usage metric may be based, at least in part, on an energy consumption associated with the first downlink communication 220-1, the second downlink communication 220-2, the first uplink communication 225-1, and the second uplink communication 225-2. For example, the energy usage metric may be associated with energy usage by the UPF 210 to transmit the first downlink communication 220-1, by the RAN 215 to receive the first downlink communication 220-1, by the RAN 215 to transmit the second downlink communication 220-2, by the UE 120 to receive the second downlink communication 220-2, by the UE 120 to transmit the first uplink communication 225-1, by the RAN 215 to receive the first uplink communication 225-1, by the RAN 215 to transmit the second uplink communication 225-2, by the UPF 210 to receive the second uplink communication 225-2, or a combination thereof, among other examples.

In some aspects, the UE 120, the UPF 210, or both, may be configured to determine, as the energy usage metric, an energy cost associated with the downlink communication 220, the uplink communication 225, or both. For example, in some aspects, the UE 120 may be configured to determine the energy cost associated with the uplink communication 225 by multiplying an energy consumption associated with the uplink communication 225 by an energy cost for the uplink communication 225. In some aspects, the energy consumption associated with the uplink communication 225 may include the energy consumption associated with the first uplink communication 225-1 and the second uplink communication 225-2. In some aspects, the energy cost associated with the uplink communication 225 may include an energy cost associated with the first uplink communication 225-1 and an energy cost associated with the second uplink communication 225-2. In some aspects, the UPF 210 may be configured to determine the energy cost associated with the downlink communication 220 by multiplying an energy consumption associated with the downlink communication 220 by an energy cost for the downlink communication 220. In some aspects, the energy consumption associated with the downlink communication 220 may include the energy consumption associated with the first downlink communication 220-1 and the second downlink communication 220-2. In some aspects, the energy cost associated with the downlink communication 220 may include an energy cost associated with the first downlink communication 220-1 and an energy cost associated with the second downlink communication 220-2. In some aspects, the energy usage metric may be associated with one or more of the energy costs over time.

As indicated above, FIG. 2 is provided as an example. Other examples may differ from what is described with respect to FIG. 2.

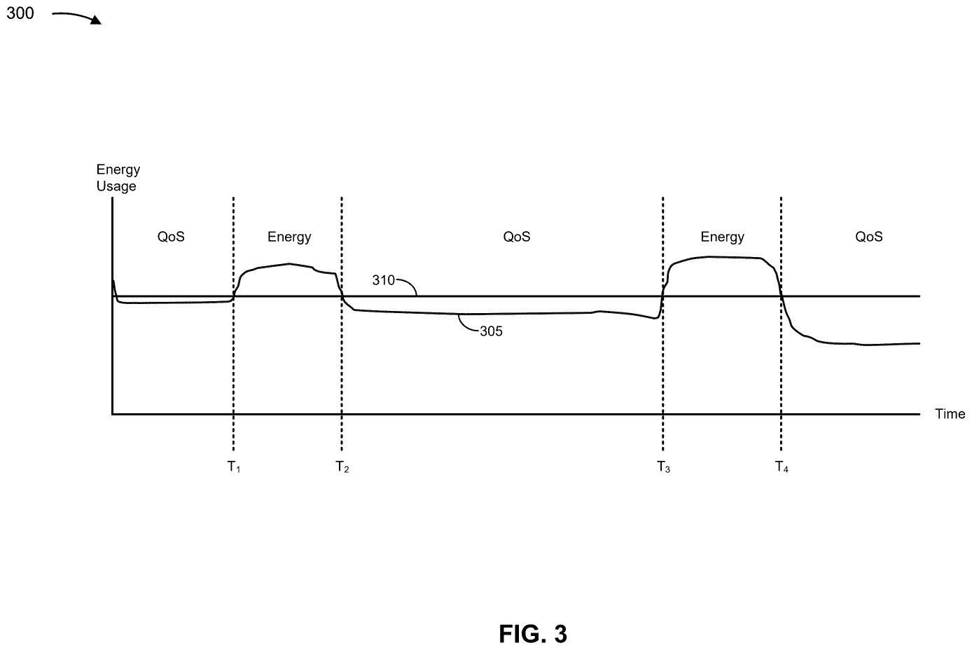

FIG. 3 is a diagram illustrating an example 300 associated with access selection criteria based on an energy usage threshold. As shown by FIG. 3, an energy usage metric 305 may be evaluated in accordance with an energy threshold 310. For example, the energy usage metric 305 may be associated with the energy consumption of a UE (e.g., UE 120) during communication with a UPF (e.g., UPF 210) via a RAN (e.g., RAN 215). The energy threshold 310 may be a configured or indicated value associated with an energy usage above which the energy usage metric should be prioritized over the QoS metric.

In some aspects, the energy usage metric 305 may be measured or estimated over time, with the energy threshold 310 operating as a reference for prioritizing either a QoS-based access network selection or an energy-based access network selection. For instance, for situations when the energy usage metric 305 satisfies (e.g., exceeds) the energy threshold 310 (such as between times T₁ and T₂ or between times T₃ and T₄ in the example 300 of FIG. 3), the sets of rules provided to the UE and to the UPF via an SMF (e.g., SMF 205) may include rules for selection criteria that prioritizes reducing energy consumption (e.g., a steering mode associated with the selection of a RAN that reduces energy usage). In some aspects, such as for situations when the energy usage metric 305 fails to satisfy (e.g., is below) the energy threshold 310 (such as before time T₁, between times T₂ and T₃ or between times T₄ and T₅ in the example 300 of FIG. 3), the sets of rules provided to the UE and to the UPF via the SMF may include rules for selection criteria that prioritizes improving QoS metrics, such as RTT or PLR (e.g., a steering mode associated with the selection of a RAN that improves communication performance).

In some aspects, the SMF may dynamically adjust the energy threshold 310 based on real-time energy consumption data or anticipated energy usage to balance energy usage and communication quality for the AN selection process. In some aspects, the SMF may transmit updated selection criteria or thresholds to the UE and to the UPF.

As indicated above, FIG. 3 is provided as an example. Other examples may differ from what is described with respect to FIG. 3.

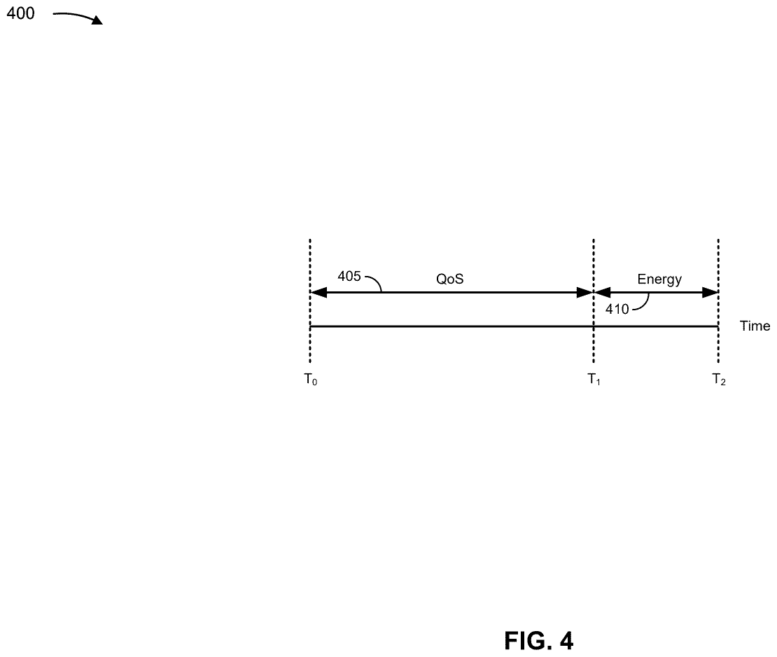

FIG. 4 is a diagram illustrating an example 400 associated with access selection criteria in accordance with a schedule. In some aspects, an SMF (e.g., SMF 205) may transmit a set of rules to the UE (e.g., UE 120) and a set of rules to the UPF (e.g., UPF 210), and the sets of rules may include the schedule for applying a QoS metric or applying an energy usage metric associated with a steering mode for an AN selection process. As shown in the example 400 of FIG. 4, the schedule may include a first time period 405 (e.g., from time T₀ to time T₁) in which the UE and the UPF are configured to apply the QoS metric in the steering mode. The schedule may also include a second time period 410 (e.g., from time T₁ to time T₂) in which the UE and the UPF are configured to apply the energy usage metric in the steering mode. As indicated above, FIG. 4 is provided as an example. Other examples may differ from what is described with regard to FIG. 4.

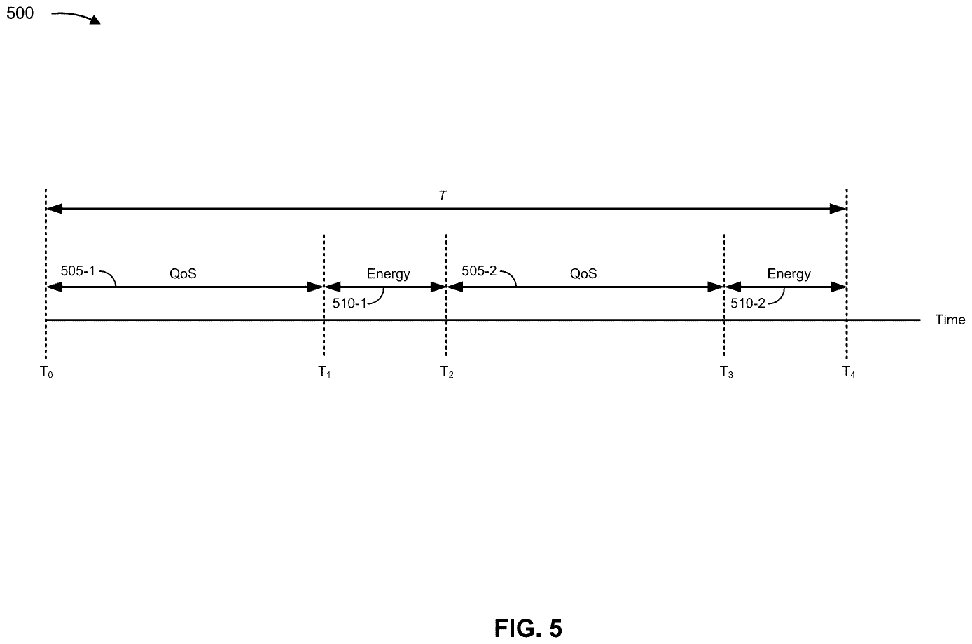

FIG. 5 is a diagram illustrating an example 500 associated with access selection criteria in accordance with percentages of time in a time window. In some aspects, an SMF (e.g., SMF 205) may transmit a set of rules to the UE (e.g., UE 120) and a set of rules to the UPF (e.g., UPF 210), and the sets of rules may include a time window T (T₄−T₀ in the example 500) and one or more percentages of time for applying a QoS metric, an energy usage metric, or both, associated with a steering mode for an AN selection process.

As shown in the example 500 of FIG. 5, in some aspects, rather than explicitly schedule times to apply the energy usage metric and the QoS metric via the sets of rules provided by the SMF to the UE and the UPF (as discussed above in the example 400 of FIG. 4), the sets of rules provided to the UE and the UPF may be associated with applying the energy usage metric for a first percentage of time and for applying the QoS metric for a second percentage of time. The first percentage of time and the second percentage of time may be associated with the time window T, and the SMF, the UE, the UPF, or a combination thereof, among other examples, may be configured to determine how to allocate the energy usage metric and the QoS metric during the time window and in accordance with the first percentage of time and the second percentage of time. In some aspects, a sum of the first percentage of time and the second percentage of time may equal 100%.

In some aspects, the SMF, the UE, or the UPF may allocate application of the energy usage metric or the QoS metric non-sequentially within the time window so long as the energy usage metric is applied for the first percentage of time during the time window and the QoS metric is applied for the second percentage of time during the time window. In some aspects, the UE or the UPF may have information about, for example, user behavior (such as current application usage or future application usage), which may be used to schedule application of the energy usage metric or QoS metric according to the first percentage of time or the second percentage of time, respectively. For example, the QoS metric may be applied during a first period 505-1 (e.g., between times To and T₁) within the time window T and during a second period 505-2 (e.g., between times T₂ and T₃) within the time window T, and the energy usage metric may be applied during a third period 510-1 (e.g., between times T₁ and T₂) within the time window T and during a fourth period 510-2 (e.g., between times T₃ and T₄) within the time window T so long as a total percentage of time the energy usage metric is applied during the time window T is the first percentage of time and a total percentage of time the QoS metric is applied during the time window Tis the second percentage of time. In the example 500, the first percentage of time (T_{EnergyUsagePercentage}) may be represented as follows:

$${T}_{EnergyUsagePercentage} = 100 * \frac{( {T}_{2} - {T}_{1} ) + ( {T}_{4} - {T}_{3} )}{T} .$$

As indicated above, FIG. 5 is provided as an example. Other examples may differ from what is described with regard to FIG. 5.

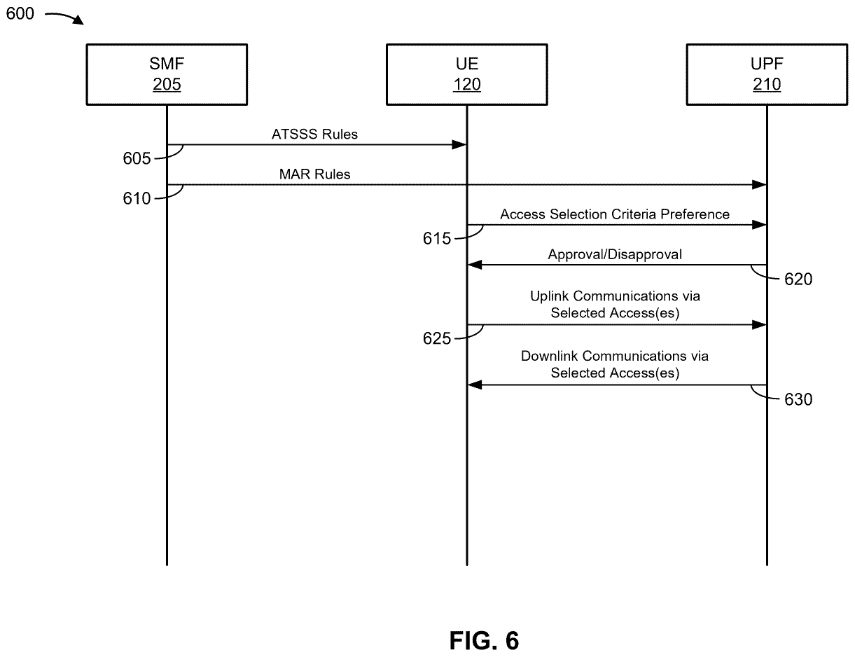

FIG. 6 is a diagram illustrating an example 600 associated with a steering mode for AN selection. As shown in FIG. 6, an SMF 205, UPF 210, and UE 120 may communicate with one another.

As shown by reference number 605, the SMF 205 may transmit, and the UE 120 may receive, a first set of rules associated with a steering mode for AN selection in accordance with an energy usage metric and a QoS metric associated with communication with the UPF 210 via at least one AN. In some aspects, the first set of rules may be a set of rules associated with an ATSSS protocol. In some aspects, the first set of rules may include a primary entity indication that identifies the UPF 210 as a primary entity for selecting criteria for the steering mode. As the primary entity, the UPF 210 may determine the criteria for the steering mode. Alternatively, the SMF 205 may transmit the primary entity indication to the UE 120 as a separate communication than a communication with the first set of rules. By transmitting the primary entity indication separately from the first set of rules, the SMF 205 may dynamically change the primary entity.

As shown by reference number 610, the SMF 205 may transmit, and the UPF 210 may receive, a second set of rules associated with the steering mode for AN selection in accordance with the energy usage metric and the QoS metric associated with communication with the UE 120 via at least one AN. In some aspects, the second set of rules may be a set of rules associated with an MAR protocol. In some aspects, the second set of rules may indicate that the UPF 210 is the primary entity. Alternatively, the SMF 205 may transmit the primary entity indication to the UPF 210 as a separate communication than a communication with the second set of rules.

As shown by reference number 615, the UE 120 may transmit, and the UPF 210 may receive, a criteria preference (e.g., an access selection criteria preference). The criteria preference may indicate a preference, by the UE 120, for the energy usage metric or the QoS metric to be used in the steering mode for AN selection. In some aspects, the UE 120 may select the energy usage metric or the QoS metric in accordance with the first set of rules.

As shown by reference number 620, the UPF 210 may transmit, and the UE 120 may receive, an approval indication or a disapproval indication. In some aspects, the approval indication or the disapproval indication may be associated with the criteria preference transmitted by the UE 120 to the UPF 210. The UPF 210 may transmit the approval indication as a result of the UPF 210 approving of the criteria preference (e.g., selecting the same criterion) of the UE 120 for the steering mode in accordance with the second set of rules. Alternatively, the UPF 210 may transmit the disapproval indication as a result of the UPF 210 selecting a different criterion for the steering mode in accordance with the second set of rules.

As shown by reference number 625, the UE 120 may transmit, and the UPF 210 may receive, one or more uplink communications. In some aspects, the uplink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As shown by reference number 630, the UPF 210 may transmit, and the UE 120 may receive, one or more downlink communications. In some aspects, the downlink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As indicated above, FIG. 6 is provided as an example. Other examples may differ from what is described with respect to FIG. 6.

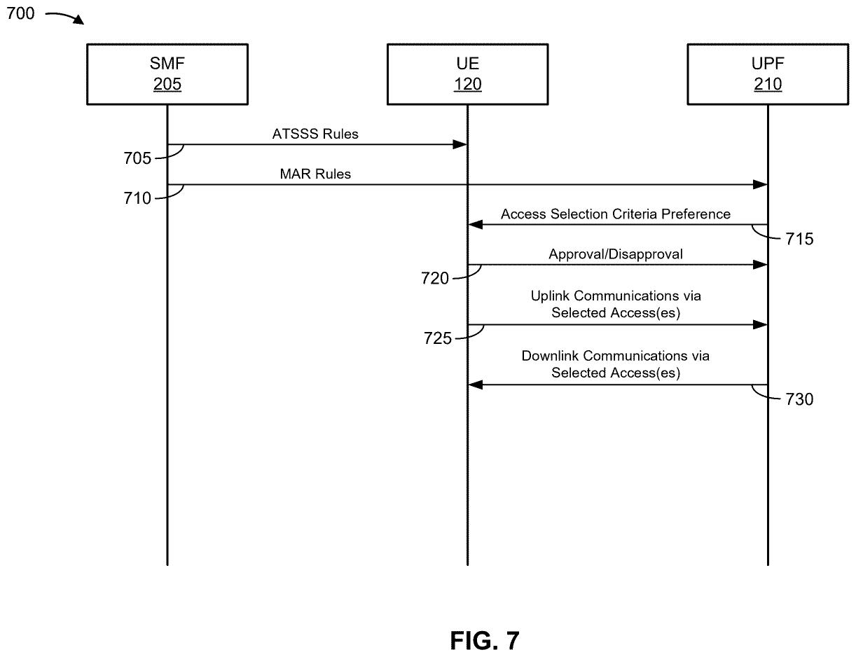

FIG. 7 is a diagram illustrating an example 700 associated with a steering mode for AN selection. As shown in FIG. 7, an SMF 205, UPF 210, and UE 120 may communicate with one another.

As shown by reference number 705, the SMF 205 may transmit, and the UE 120 may receive, a first set of rules associated with a steering mode for AN selection in accordance with an energy usage metric and a QoS metric associated with communication with the UPF 210 via at least one AN. In some aspects, the first set of rules may be a set of rules associated with an ATSSS protocol. In some aspects, the first set of rules may include a primary entity indication that identifies the UE 120 as a primary entity for selecting criteria for the steering mode. As the primary entity, the UE 120 may determine the criteria for the steering mode. Alternatively, the SMF 205 may transmit the primary entity indication to the UE 120 as a separate communication than a communication with the first set of rules. By transmitting the primary entity indication separately from the first set of rules, the SMF 205 may dynamically change the primary entity.

As shown by reference number 710, the SMF 205 may transmit, and the UPF 210 may receive, a second set of rules associated with the steering mode for AN selection in accordance with the energy usage metric and the QoS metric associated with communication with the UE 120 via at least one AN. In some aspects, the second set of rules may be a set of rules associated with an MAR protocol. In some aspects, the second set of rules may indicate that the UE 120 is the primary entity. Alternatively, the SMF 205 may transmit the primary entity indication to the UPF 210 as a separate communication than a communication with the second set of rules.

As shown by reference number 715, the UPF 210 may transmit, and the UE 120 may receive, a criteria preference (e.g., an access criteria preference). The criteria preference may indicate a preference, by the UPF 210, for the energy usage metric or the QoS metric to be used in the steering mode for AN selection. In some aspects, the UPF 210 may select the energy usage metric or the QoS metric in accordance with the first set of rules.

As shown by reference number 720, the UE 120 may transmit, and the UPF 210 may receive, an approval indication or a disapproval indication. In some aspects, the approval indication or the disapproval indication may be associated with the criteria preference transmitted by the UPF 210 to the UE 120. The UE 120 may transmit the approval indication as a result of the UE 120 approving of the criteria preference (e.g., selecting the same criterion) of the UPF 210 for the steering mode in accordance with the first set of rules. Alternatively, the UE 120 may transmit the disapproval indication as a result of the UE 120 selecting a different criterion for the steering mode in accordance with the first set of rules.

As shown by reference number 725, the UE 120 may transmit, and the UPF 210 may receive, one or more uplink communications. In some aspects, the uplink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As shown by reference number 730, the UPF 210 may transmit, and the UE 120 may receive, one or more downlink communications. In some aspects, the downlink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As indicated above, FIG. 7 is provided as an example. Other examples may differ from what is described with respect to FIG. 7.

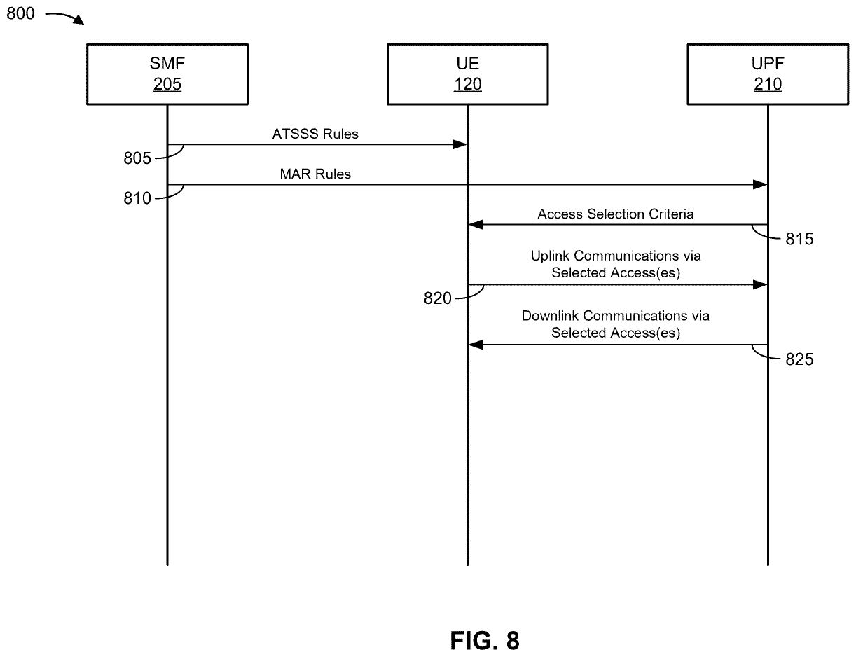

FIG. 8 is a diagram illustrating an example 800 associated with a steering mode for AN selection. As shown in FIG. 8, an SMF 205, UPF 210, and UE 120 may communicate with one another.

As shown by reference number 805, the SMF 205 may transmit, and the UE 120 may receive, a first set of rules associated with a steering mode for AN selection in accordance with an energy usage metric and a QoS metric associated with communication with the UPF 210 via at least one AN. In some aspects, the first set of rules may be a set of rules associated with an ATSSS protocol. In some aspects, the first set of rules may include a primary entity indication that identifies the UPF 210 as a primary entity for selecting criteria for the steering mode. As the primary entity, the UPF 210 may determine the criteria for the steering mode. Alternatively, the SMF 205 may transmit the primary entity indication to the UE 120 as a separate communication than a communication with the first set of rules. By transmitting the primary entity indication separately from the first set of rules, the SMF 205 may dynamically change the primary entity.

As shown by reference number 810, the SMF 205 may transmit, and the UPF 210 may receive, a second set of rules associated with the steering mode for AN selection in accordance with the energy usage metric and the QoS metric associated with communication with the UE 120 via at least one AN. In some aspects, the second set of rules may be a set of rules associated with an MAR protocol. In some aspects, the second set of rules may indicate that the UPF 210 is the primary entity. Alternatively, the SMF 205 may transmit the primary entity indication to the UPF 210 as a separate communication than a communication with the second set of rules.

As shown by reference number 815, the UPF 210 may transmit, and the UE 120 may receive, an access selection criteria indication. The access selection criteria indication may indicate a selection, by the UPF 210, for the energy usage metric or the QoS metric to be used in the steering mode for AN selection. In some aspects, the UPF 210 may select the energy usage metric or the QoS metric in accordance with the second set of rules. The UPF 210 and the UE 120 may proceed with the access selection in accordance with the steering mode. In some aspects, the UPF 210 and the UE 120 may select the RAN in accordance with the access selection criteria indicated by the UPF 210.

As shown by reference number 820, the UE 120 may transmit, and the UPF 210 may receive, one or more uplink communications. In some aspects, the uplink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As shown by reference number 825, the UPF 210 may transmit, and the UE 120 may receive, one or more downlink communications. In some aspects, the downlink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As indicated above, FIG. 8 is provided as an example. Other examples may differ from what is described with respect to FIG. 8.

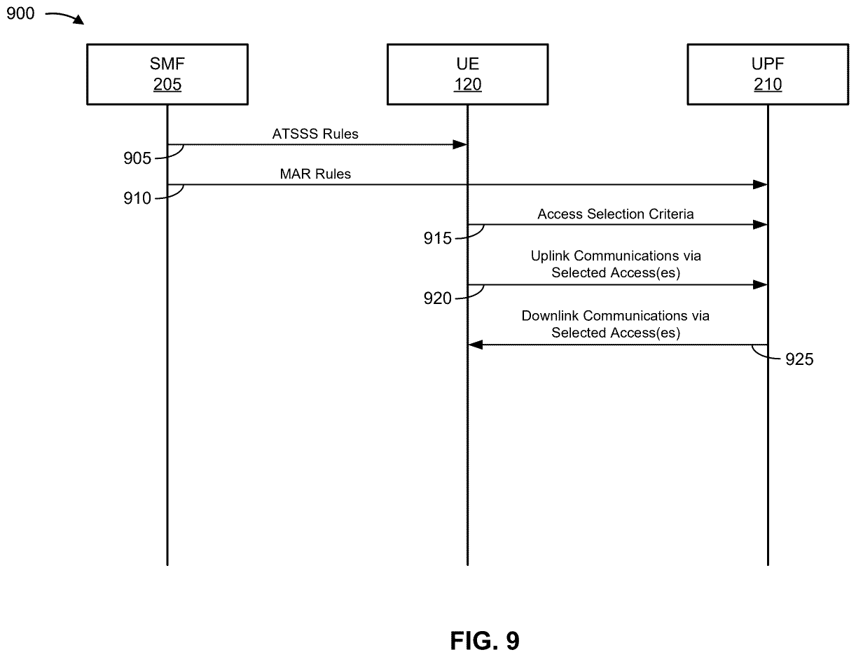

FIG. 9 is a diagram illustrating an example 900 associated with a steering mode for AN selection. As shown in FIG. 9, an SMF 205, UPF 210, and UE 120 may communicate with one another.

As shown by reference number 905, the SMF 205 may transmit, and the UE 120 may receive, a first set of rules associated with a steering mode for AN selection in accordance with an energy usage metric and a QoS metric associated with communication with the UPF 210 via at least one AN. In some aspects, the first set of rules may be a set of rules associated with an ATSSS protocol. In some aspects, the first set of rules may include a primary entity indication that identifies the UE 120 as a primary entity for selecting criteria for the steering mode. As the primary entity, the UE 120 may determine the criteria for the steering mode. Alternatively, the SMF 205 may transmit the primary entity indication to the UE 120 as a separate communication than a communication with the first set of rules. By transmitting the primary entity indication separately from the first set of rules, the SMF 205 may dynamically change the primary entity.

As shown by reference number 910, the SMF 205 may transmit, and the UPF 210 may receive, a second set of rules associated with the steering mode for AN selection in accordance with the energy usage metric and the QoS metric associated with communication with the UE 120 via at least one AN. In some aspects, the second set of rules may be a set of rules associated with an MAR protocol. In some aspects, the second set of rules may indicate that the UE 120 is the primary entity. Alternatively, the SMF 205 may transmit the primary entity indication to the UPF 210 as a separate communication than a communication with the second set of rules.

As shown by reference number 915, the UE 120 may transmit, and the UPF 210 may receive, an access selection criteria indication. The access selection criteria indication may indicate a selection, by the UE 120, for the energy usage metric or the QoS metric to be used in the steering mode for AN selection. In some aspects, the UE 120 may select the energy usage metric or the QoS metric in accordance with the first set of rules. The UPF 210 and the UE 120 may proceed with the AN selection in accordance with the steering mode. In some aspects, the UPF 210 and the UE 120 may select the RAN in accordance with the access selection criteria indicated by the UE 120.

As shown by reference number 920, the UE 120 may transmit, and the UPF 210 may receive, one or more uplink communications. In some aspects, the uplink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As shown by reference number 925, the UPF 210 may transmit, and the UE 120 may receive, one or more downlink communications. In some aspects, the downlink communications are transmitted via the at least one AN selected in accordance with the energy usage metric, the QoS metric, or a combination thereof, among other examples. In some aspects, the RAN is selected in accordance with the first set of rules, the second set of rules, the primary entity indication, the approval indication or disapproval indication, the criteria preference, or a combination thereof, among other examples.

As indicated above, FIG. 9 is provided as an example. Other examples may differ from what is described with respect to FIG. 9.

FIG. 10 is a diagram illustrating an example process 1000 performed, for example, at a UE or an apparatus of a UE. Example process 1000 is an example where the apparatus or the UE (e.g., UE 120) performs operations associated with a steering mode for AN selection.

As shown in FIG. 10, in some aspects, process 1000 may include receiving, from a first network entity (e.g., an SMF), a set of rules associated with a steering mode for AN selection in accordance with an energy usage metric and a QoS metric associated with communication with a UPF via at least one AN (block 1010). For example, the UE (e.g., using reception component 1302 or communication manager 1306, depicted in FIG. 13) may receive, from an SMF, a set of rules associated with a steering mode for AN selection in accordance with an energy usage metric and a QoS metric associated with communication with a second network entity (e.g., a UPF) via at least one AN, as described above.

As further shown in FIG. 10, in some aspects, process 1000 may include transmitting, via the at least one AN selected in accordance with the set of rules, an uplink communication to the UPF (block 1020). For example, the UE (e.g., using transmission component 1304 or communication manager 1306, depicted in FIG. 13) may transmit, via the at least one AN selected in accordance with the set of rules, an uplink communication to the UPF, as described above.

As further shown in FIG. 10, in some aspects, process 1000 may include receiving, via the at least one AN selected in accordance with the set of rules, a downlink communication from the UPF (block 1030). For example, the UE (e.g., using reception component 1302 or communication manager 1306, depicted in FIG. 13) may receive, via the at least one AN selected in accordance with the set of rules, a downlink communication from the UPF, as described above.

Process 1000 may include additional aspects, such as any single aspect or any combination of aspects described below or in connection with one or more other processes described elsewhere herein.

In a first aspect, process 1000 includes measuring or estimating the energy usage metric in accordance with the one or more rules associated with the steering mode, comparing the energy usage metric to an energy threshold, and selecting the at least one AN in accordance with the energy usage metric satisfying the energy threshold, wherein the energy usage metric is associated with one or more of the uplink communication or the downlink communication.

In a second aspect, alone or in combination with the first aspect, process 1000 includes receiving, from the SMF, an indication or configuration for the energy threshold.

In a third aspect, alone or in combination with one or more of the first and second aspects, process 1000 includes measuring or estimating the QoS metric in accordance with the one or more rules for the steering mode, comparing the QoS metric to a quality threshold, and selecting the at least one AN in accordance with the QoS metric satisfying the quality threshold, wherein the QoS metric is associated with one or more of the uplink communication or the downlink communication, and wherein the QoS metric includes one or more of a RTT or a PLR.

In a fourth aspect, alone or in combination with one or more of the first through third aspects, process 1000 includes receiving, from the SMF, an indication or configuration for the quality threshold.

In a fifth aspect, alone or in combination with one or more of the first through fourth aspects, the one or more rules associated with the steering mode include a schedule for applying one of the energy usage metric or the QoS metric for AN selection.

In a sixth aspect, alone or in combination with one or more of the first through fifth aspects, the one or more rules associated with the steering mode include one or more rules associated with a first time window for applying the energy usage metric and a second time window for applying the QoS metric.

In a seventh aspect, alone or in combination with one or more of the first through sixth aspects, the one or more rules associated with the steering mode include one or more rules for applying the energy usage metric for a first percentage of time and for applying the QoS metric for a second percentage of time.

In an eighth aspect, alone or in combination with one or more of the first through seventh aspects, process 1000 includes receiving, from the SMF, a primary entity indication indicating one of the UE or the UPF as a primary entity for selecting criteria for the steering mode.

In a ninth aspect, alone or in combination with one or more of the first through eighth aspects, process 1000 includes transmitting a criteria selection indication to the UPF.

In a tenth aspect, alone or in combination with one or more of the first through ninth aspects, process 1000 includes receiving, from the UPF, a criteria preference indication.

In an eleventh aspect, alone or in combination with one or more of the first through tenth aspects, the set of rules for the steering mode include one or more rules for selecting the at least one AN in accordance with the criteria preference indication of the UPF.

In a twelfth aspect, alone or in combination with one or more of the first through eleventh aspects, process 1000 includes transmitting, to the UPF, an approval indication or a disapproval indication associated with the criteria preference indication of the UPF.

In a thirteenth aspect, alone or in combination with one or more of the first through twelfth aspects, process 1000 includes receiving a criteria selection indication from the UPF.

In a fourteenth aspect, alone or in combination with one or more of the first through thirteenth aspects, process 1000 includes transmitting, to the UPF, a criteria preference indication.

In a fifteenth aspect, alone or in combination with one or more of the first through fourteenth aspects, process 1000 includes receiving, from the UPF, an approval indication or a disapproval indication associated with the criteria preference indication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UPF or an apparatus of a UPF. Example process 1100 is an example where the apparatus or the UPF (e.g., UPF 210]) performs operations associated with a steering mode for AN selection.

As shown in FIG. 11, in some aspects, process 1100 may include receiving, from a network entity (e.g., an SMF), a set of rules associated with a steering mode for AN selection in accordance with an energy usage metric and a QoS metric associated with communication with a UE via at least one AN (block 1110). For example, the UPF (e.g., using reception component 1402 or communication manager 1406, depicted in FIG. 14) may receive, from an SMF, a set of rules associated with a steering mode for AN selection in accordance with an energy usage metric and a QoS metric associated with communication with a UE via at least one AN, as described above.

As further shown in FIG. 11, in some aspects, process 1100 may include receiving, via the at least one AN selected in accordance with the set of rules, an uplink communication from the UE (block 1120). For example, the UPF (e.g., using reception component 1402 or communication manager 1406, depicted in FIG. 14) may receive, via the at least one AN selected in accordance with the set of rules, an uplink communication from the UE, as described above.

As further shown in FIG. 11, in some aspects, process 1100 may include transmitting, via the at least one AN selected in accordance with the set of rules, a downlink communication to the UE (block 1130). For example, the UPF (e.g., using transmission component 1404 or communication manager 1406, depicted in FIG. 14) may transmit, via the at least one AN selected in accordance with the set of rules, a downlink communication to the UE, as described above.

Process 1100 may include additional aspects, such as any single aspect or any combination of aspects described below or in connection with one or more other processes described elsewhere herein.

In a first aspect, process 1100 includes measuring or estimating the energy usage metric in accordance with the one or more rules associated with the steering mode, comparing the energy usage metric to an energy threshold, and selecting the at least one AN in accordance with the energy usage metric satisfying the energy threshold, wherein the energy usage metric is associated with one or more of the uplink communication or the downlink communication.

In a second aspect, alone or in combination with the first aspect, process 1100 includes receiving, from the SMF, an indication or configuration for the energy threshold.

In a third aspect, alone or in combination with one or more of the first and second aspects, process 1100 includes measuring or estimating the QoS metric in accordance with the one or more rules for the steering mode, comparing the QoS metric to a quality threshold, and selecting the at least one AN in accordance with the QoS metric satisfying the quality threshold, wherein the QoS metric is associated with one or more of the uplink communication or the downlink communication, and wherein the QoS metric includes one or more of a RTT or a PLR.

In a fourth aspect, alone or in combination with one or more of the first through third aspects, process 1100 includes receiving, from the SMF, an indication or configuration for the quality threshold.

In a fifth aspect, alone or in combination with one or more of the first through fourth aspects, the one or more rules associated with the steering mode include a schedule for applying one of the energy usage metric or the QoS metric for AN selection.

In a sixth aspect, alone or in combination with one or more of the first through fifth aspects, the one or more rules associated with the steering mode include one or more rules associated with a first time window for applying the energy usage metric and a second time window for applying the QoS metric.

In a seventh aspect, alone or in combination with one or more of the first through sixth aspects, the one or more rules associated with the steering mode include one or more rules for applying the energy usage metric for a first percentage of time and for applying the QoS metric for a second percentage of time.

In an eighth aspect, alone or in combination with one or more of the first through seventh aspects, process 1100 includes receiving, from the SMF, a primary entity indication indicating one of the UE or the UPF as a primary entity for selecting criteria for the steering mode.

In a ninth aspect, alone or in combination with one or more of the first through eighth aspects, process 1100 includes transmitting a criteria selection indication to the UE.

In a tenth aspect, alone or in combination with one or more of the first through ninth aspects, process 1100 includes receiving, from the UE, a criteria preference indication.

In an eleventh aspect, alone or in combination with one or more of the first through tenth aspects, the set of rules for the steering mode include one or more rules for selecting the at least one AN in accordance with the criteria preference indication of the UE.

In a twelfth aspect, alone or in combination with one or more of the first through eleventh aspects, process 1100 includes transmitting, to the UE, an approval indication or a disapproval indication associated with the criteria preference indication of the UPF.

In a thirteenth aspect, alone or in combination with one or more of the first through twelfth aspects, process 1100 includes receiving a criteria selection indication from the UE.

In a fourteenth aspect, alone or in combination with one or more of the first through thirteenth aspects, process 1100 includes transmitting, to the UE, a criteria preference indication.

In a fifteenth aspect, alone or in combination with one or more of the first through fourteenth aspects, process 1100 includes receiving, from the UE, an approval indication or a disapproval indication associated with the criteria preference indication.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at an SMF or an apparatus of an SMF. Example process 1200 is an example where the apparatus or the SMF (e.g., SMF 205) performs operations associated with a steering mode for AN selection.

As shown in FIG. 12, in some aspects, process 1200 may include transmitting, to a UE, a first set of rules associated with a steering mode for AN selection in accordance with an energy usage metric and a QoS metric (block 1210). For example, the SMF (e.g., using transmission component 1504 or communication manager 1506, depicted in FIG. 15) may transmit, to a UE, a first set of rules associated with a steering mode for AN selection in accordance with an energy usage metric and a QoS metric, as described above.

As further shown in FIG. 12, in some aspects, process 1200 may include transmitting, to a network entity (e.g., a UPF), a second set of rules associated with the steering mode for AN selection in accordance with the energy usage metric and the QoS metric (block 1220). For example, the SMF (e.g., using transmission component 1504 or communication manager 1506, depicted in FIG. 15) may transmit, to a UPF, a second set of rules associated with the steering mode for AN selection in accordance with the energy usage metric and the QoS metric, as described above.

Process 1200 may include additional aspects, such as any single aspect or any combination of aspects described below or in connection with one or more other processes described elsewhere herein.

In a first aspect, process 1200 includes transmitting, to one or more of the UE or the UPF, an indication or configuration for an energy threshold.

In a second aspect, alone or in combination with the first aspect, process 1200 includes transmitting, to one or more of the UE or the UPF, an indication or configuration for a quality threshold.

In a third aspect, alone or in combination with one or more of the first and second aspects, the first set of rules associated with the steering mode and the second set of rules associated with the steering mode each include a schedule for applying one of the energy usage metric or the QoS metric for AN selection.

In a fourth aspect, alone or in combination with one or more of the first through third aspects, the first set of rules associated with the steering mode and the second set of rules associated with the steering mode each include one or more rules associated with a first time window for applying the energy usage metric and a second time window for applying the QoS metric.

In a fifth aspect, alone or in combination with one or more of the first through fourth aspects, the first set of rules associated with the steering mode and the second set of rules associated with the steering mode each include one or more rules for applying the energy usage metric for a first percentage of time and for applying the QoS metric for a second percentage of time.

In a sixth aspect, alone or in combination with one or more of the first through fifth aspects, process 1200 includes transmitting, to the UE and to the UPF, a primary entity indication indicating one of the UE or the UPF as a primary entity for selecting criteria for the steering mode.

In a seventh aspect, alone or in combination with one or more of the first through sixth aspects, the first set of rules for the steering mode and the second set of rules for the steering mode each include one or more rules for the UE to select the at least one AN in accordance with a criteria preference indication of the UPF.

In an eighth aspect, alone or in combination with one or more of the first through seventh aspects, the first set of rules for the steering mode and the second set of rules for the steering mode each include one or more rules for the UPF to select the at least one AN in accordance with a criteria preference indication of the UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 2-9. Additionally, or alternatively, the apparatus 1300 may be configured to perform one or more processes described herein, such as process 1000 of FIG. 10. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive, from a first network entity (e.g., an SMF), a set of rules associated with a steering mode for AN selection in accordance with an energy usage metric and a QoS metric associated with communication with a second network entity (e.g., a UPF) via at least one AN. The transmission component 1304 may transmit, via the at least one AN selected in accordance with the set of rules, an uplink communication to the UPF. The reception component 1302 may receive, via the at least one AN selected in accordance with the set of rules, a downlink communication from the UPF.

The communication manager 1306 may measure or estimate the energy usage metric in accordance with the one or more rules associated with the steering mode. The communication manager 1306 may compare the energy usage metric to an energy threshold. The communication manager 1306 may select the at least one AN in accordance with the energy usage metric satisfying the energy threshold wherein the energy usage metric is associated with one or more of the uplink communication or the downlink communication. The reception component 1302 may receive, from the SMF, an indication or configuration for the energy threshold. The communication manager 1306 may measure or estimate the QoS metric in accordance with the one or more rules for the steering mode comparing the QoS metric to a quality threshold; and selecting the at least one AN in accordance with the QoS metric satisfying the quality threshold, wherein the QoS metric is associated with one or more of the uplink communication or the downlink communication, and wherein the QoS metric includes one or more of a RTT or a PLR. The reception component 1302 may receive, from the SMF, an indication or configuration for the quality threshold. The reception component 1302 may receive, from the SMF, a primary entity indication indicating one of the UE or the UPF as a primary entity for selecting criteria for the steering mode.

The transmission component 1304 may transmit a criteria selection indication to the UPF. The reception component 1302 may receive, from the UPF, a criteria preference indication. The transmission component 1304 may transmit, to the UPF, an approval indication or a disapproval indication associated with the criteria preference indication of the UPF. The reception component 1302 may receive a criteria selection indication from the UPF. The transmission component 1304 may transmit, to the UPF, a criteria preference indication. The reception component 1302 may receive, from the UPF, an approval indication or a disapproval indication associated with the criteria preference indication.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a UPF, or a UPF may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the UPF.

In some aspects, the apparatus 1400 may be configured to perform one or more operations described herein in connection with FIGS. 2-9. Additionally, or alternatively, the apparatus 1400 may be configured to perform one or more processes described herein, such as process 1100 of FIG. 11. In some aspects, the apparatus 1400 or one or more components shown in FIG. 14 may include one or more components of the UPF described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UPF described above in connection with FIG. 1, such as a radio, one or more RF chains, one or more transceivers, or one or more modems, each of which may in turn be coupled with one or more antennas of the UPF.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UPF described above in connection with FIG. 1, such as a radio, one or more RF chains, one or more transceivers, or one or more modems, each of which may in turn be coupled with one or more antennas of the UPF described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 may receive, from a network entity (e.g., an SMF), a set of rules associated with a steering mode for AN selection in accordance with an energy usage metric and a QoS metric associated with communication with a UE via at least one AN. The reception component 1402 may receive, via the at least one AN selected in accordance with the set of rules, an uplink communication from the UE. The transmission component 1404 may transmit, via the at least one AN selected in accordance with the set of rules, a downlink communication to the UE. The communication manager 1406 may measure or estimate the energy usage metric in accordance with the one or more rules associated with the steering mode. The communication manager 1406 may compare the energy usage metric to an energy threshold. The communication manager 1406 may select the at least one AN in accordance with the energy usage metric satisfying the energy threshold wherein the energy usage metric is associated with one or more of the uplink communication or the downlink communication. The reception component 1402 may receive, from the SMF, an indication or configuration for the energy threshold. The communication manager 1406 may measure or estimate the QoS metric in accordance with the one or more rules for the steering mode. The communication manager 1406 may compare the QoS metric to a quality threshold. The communication manager 1406 may select the at least one AN in accordance with the QoS metric satisfying the quality threshold wherein the QoS metric is associated with one or more of the uplink communication or the downlink communication, and wherein the QoS metric includes one or more of a RTT or a PLR. The reception component 1402 may receive, from the SMF, an indication or configuration for the quality threshold. The reception component 1402 may receive, from the SMF, a primary entity indication indicating one of the UE or the UPF as a primary entity for selecting criteria for the steering mode. The transmission component 1404 may transmit a criteria selection indication to the UE. The reception component 1402 may receive, from the UE, a criteria preference indication. The transmission component 1404 may transmit, to the UE, an approval indication or a disapproval indication associated with the criteria preference indication of the UPF. The reception component 1402 may receive a criteria selection indication from the UE. The transmission component 1404 may transmit, to the UE, a criteria preference indication. The reception component 1402 may receive, from the UE, an approval indication or a disapproval indication associated with the criteria preference indication.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be an SMF, or an SMF may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the SMF.

In some aspects, the apparatus 1500 may be configured to perform one or more operations described herein in connection with FIGS. 2-9. Additionally, or alternatively, the apparatus 1500 may be configured to perform one or more processes described herein, such as process 1200 of FIG. 12. In some aspects, the apparatus 1500 or one or more components shown in FIG. 15 may include one or more components of the SMF described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the SMF described above in connection with FIG. 1, such as a radio, one or more RF chains, one or more transceivers, or one or more modems, each of which may in turn be coupled with one or more antennas of the SMF.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the SMF described above in connection with FIG. 1, such as a radio, one or more RF chains, one or more transceivers, or one or more modems, each of which may in turn be coupled with one or more antennas of the SMF described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The transmission component 1504 may transmit, to a UE, a first set of rules associated with a steering mode for AN selection in accordance with an energy usage metric and a QoS metric. The transmission component 1504 may transmit, to a network entity (e.g., a UPF), a second set of rules associated with the steering mode for AN selection in accordance with the energy usage metric and the QoS metric. The transmission component 1504 may transmit, to one or more of the UE or the UPF, an indication or configuration for an energy threshold. The transmission component 1504 may transmit, to one or more of the UE or the UPF, an indication or configuration for a quality threshold. The transmission component 1504 may transmit, to the UE and to the UPF, a primary entity indication indicating one of the UE or the UPF as a primary entity for selecting criteria for the steering mode.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a UE, comprising: receiving, from a first network entity, a set of rules associated with a steering mode for AN selection in accordance with an energy usage metric and a QoS metric associated with communication with a second network entity via at least one AN; transmitting, via the at least one AN selected in accordance with the set of rules, an uplink communication to the UPF; and receiving, via the at least one AN selected in accordance with the set of rules, a downlink communication from the UPF.
Aspect 2: The method of Aspect 1, further comprising: measuring or estimating the energy usage metric in accordance with the one or more rules associated with the steering mode; comparing the energy usage metric to an energy threshold; and selecting the AN in accordance with the energy usage metric satisfying the energy threshold, wherein the energy usage metric is associated with one or more of the uplink communication or the downlink communication.
Aspect 3: The method of Aspect 2, further comprising receiving, from the SMF, an indication or configuration for the energy threshold.
Aspect 4: The method of any of Aspects 1-3, further comprising: measuring or estimating the QoS metric in accordance with the one or more rules for the steering mode; comparing the QoS metric to a quality threshold; and selecting the AN in accordance with the QoS metric satisfying the quality threshold, wherein the QoS metric is associated with one or more of the uplink communication or the downlink communication, and wherein the QoS metric includes one or more of a RTT or a PLR.
Aspect 5: The method of Aspect 4, further comprising receiving, from the SMF, an indication or configuration for the quality threshold.
Aspect 6: The method of any of Aspects 1-5, wherein the one or more rules associated with the steering mode include a schedule for applying one of the energy usage metric or the QoS metric for AN selection.
Aspect 7: The method of any of Aspects 1-6, wherein the one or more rules associated with the steering mode include one or more rules associated with a first time window for applying the energy usage metric and a second time window for applying the QoS metric.
Aspect 8: The method of any of Aspects 1-7, wherein the one or more rules associated with the steering mode include one or more rules for applying the energy usage metric for a first percentage of time and for applying the QoS metric for a second percentage of time.
Aspect 9: The method of any of Aspects 1-8, further comprising receiving, from the SMF, a primary entity indication indicating one of the UE or the UPF as a primary entity for selecting criteria for the steering mode.
Aspect 10: The method of any of Aspects 1-9, further comprising transmitting a criteria selection indication to the UPF.
Aspect 11: The method of any of Aspects 1-10, further comprising receiving, from the UPF, a criteria preference indication.
Aspect 12: The method of Aspect 11, wherein the set of rules for the steering mode include one or more rules for selecting the AN in accordance with the criteria preference indication of the UPF.
Aspect 13: The method of Aspect 11, further comprising transmitting, to the UPF, an approval indication or a disapproval indication associated with the criteria preference indication of the UPF.
Aspect 14: The method of any of Aspects 1-13, further comprising receiving a criteria selection indication from the UPF.
Aspect 15: The method of any of Aspects 1-14, further comprising transmitting, to the UPF, a criteria preference indication.
Aspect 16: The method of Aspect 15, further comprising receiving, from the UPF, an approval indication or a disapproval indication associated with the criteria preference indication.
Aspect 17: A method of wireless communication performed by a UPF, comprising: receiving, from a network entity, a set of rules associated with a steering mode for AN selection in accordance with an energy usage metric and a QoS metric associated with communication with a UE via at least one AN; receiving, via the at least one AN selected in accordance with the set of rules, an uplink communication from the UE; and transmitting, via the at least one AN selected in accordance with the set of rules, a downlink communication to the UE.
Aspect 18: The method of Aspect 17, further comprising: measuring or estimating the energy usage metric in accordance with the one or more rules associated with the steering mode; comparing the energy usage metric to an energy threshold; and selecting the AN in accordance with the energy usage metric satisfying the energy threshold, wherein the energy usage metric is associated with one or more of the uplink communication or the downlink communication.
Aspect 19: The method of Aspect 18, further comprising receiving, from the SMF, an indication or configuration for the energy threshold.
Aspect 20: The method of any of Aspects 17-19, further comprising: measuring or estimating the QoS metric in accordance with the one or more rules for the steering mode; comparing the QoS metric to a quality threshold; and selecting the AN in accordance with the QoS metric satisfying the quality threshold, wherein the QoS metric is associated with one or more of the uplink communication or the downlink communication, and wherein the QoS metric includes one or more of a RTT or a PLR.
Aspect 21: The method of Aspect 20, further comprising receiving, from the SMF, an indication or configuration for the quality threshold.
Aspect 22: The method of any of Aspects 17-21, wherein the one or more rules associated with the steering mode include a schedule for applying one of the energy usage metric or the QoS metric for AN selection.
Aspect 23: The method of any of Aspects 17-22, wherein the one or more rules associated with the steering mode include one or more rules associated with a first time window for applying the energy usage metric and a second time window for applying the QoS metric.
Aspect 24: The method of any of Aspects 17-23, wherein the one or more rules associated with the steering mode include one or more rules for applying the energy usage metric for a first percentage of time and for applying the QoS metric for a second percentage of time.
Aspect 25: The method of any of Aspects 17-24, further comprising receiving, from the network entity, a primary entity indication indicating one of the UE or the UPF as a primary entity for selecting criteria for the steering mode.
Aspect 26: The method of any of Aspects 17-25, further comprising transmitting a criteria selection indication to the UE.
Aspect 27: The method of any of Aspects 17-26, further comprising receiving, from the UE, a criteria preference indication.
Aspect 28: The method of Aspect 27, wherein the set of rules for the steering mode include one or more rules for selecting the AN in accordance with the criteria preference indication of the UE.
Aspect 29: The method of Aspect 27, further comprising transmitting, to the UE, an approval indication or a disapproval indication associated with the criteria preference indication of the UPF.
Aspect 30: The method of any of Aspects 17-29, further comprising receiving a criteria selection indication from the UE.
Aspect 31: The method of any of Aspects 17-30, further comprising transmitting, to the UE, a criteria preference indication.
Aspect 32: The method of Aspect 31, further comprising receiving, from the UE, an approval indication or a disapproval indication associated with the criteria preference indication.
Aspect 33: A method of wireless communication performed by an SMF, comprising: transmitting, to a UE, a first set of rules associated with a steering mode for AN selection in accordance with an energy usage metric and a QoS metric; and transmitting, to a network entity, a second set of rules associated with the steering mode for AN selection in accordance with the energy usage metric and the QoS metric.
Aspect 34: The method of Aspect 33, further comprising transmitting, to one or more of the UE or the network entity, an indication or configuration for an energy threshold.
Aspect 35: The method of any of Aspects 33-34, further comprising transmitting, to one or more of the UE or the network entity, an indication or configuration for a quality threshold.
Aspect 36: The method of any of Aspects 33-35, wherein the first set of rules associated with the steering mode and the second set of rules associated with the steering mode each include a schedule for applying one of the energy usage metric or the QoS metric for AN selection.
Aspect 37: The method of any of Aspects 33-36, wherein the first set of rules associated with the steering mode and the second set of rules associated with the steering mode each include one or more rules associated with a first time window for applying the energy usage metric and a second time window for applying the QoS metric.
Aspect 38: The method of any of Aspects 33-37, wherein the first set of rules associated with the steering mode and the second set of rules associated with the steering mode each include one or more rules for applying the energy usage metric for a first percentage of time and for applying the QoS metric for a second percentage of time.
Aspect 39: The method of any of Aspects 33-38, further comprising transmitting, to the UE and to the network entity, a primary entity indication indicating one of the UE or the network entity as a primary entity for selecting criteria for the steering mode.
Aspect 40: The method of any of Aspects 33-39, wherein the first set of rules for the steering mode and the second set of rules for the steering mode each include one or more rules for the UE to select the at least one AN in accordance with a criteria preference indication of the network entity.
Aspect 41: The method of any of Aspects 33-40, wherein the first set of rules for the steering mode and the second set of rules for the steering mode each include one or more rules for the network entity to select the at least one AN in accordance with a criteria preference indication of the UE.
Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-41.
Aspect 43: An apparatus for wireless communication at a device, the apparatus comprising one or more memories and one or more processors coupled to the one or more memories, the one or more processors configured to cause the device to perform the method of one or more of Aspects 1-41.
Aspect 44: An apparatus for wireless communication, the apparatus comprising at least one means for performing the method of one or more of Aspects 1-41.
Aspect 45: A non-transitory computer-readable medium storing code for wireless communication, the code comprising instructions executable by one or more processors to perform the method of one or more of Aspects 1-41.
Aspect 46: A non-transitory computer-readable medium storing a set of instructions for wireless communication, the set of instructions comprising one or more instructions that, when executed by one or more processors of a device, cause the device to perform the method of one or more of Aspects 1-41.
Aspect 47: A device for wireless communication, the device comprising a processing system that includes one or more processors and one or more memories coupled with the one or more processors, the processing system configured to cause the device to perform the method of one or more of Aspects 1-41.
Aspect 48: An apparatus for wireless communication at a device, the apparatus comprising one or more memories and one or more processors coupled to the one or more memories, the one or more processors individually or collectively configured to cause the device to perform the method of one or more of Aspects 1-41.
Aspect 49: A device comprising a processing system that includes one or more processors and one or more code-storing memories coupled with the one or more processors, the processing system configured to cause the device to perform the method of one or more of Aspects 1-41.
Aspect 50: A device comprising a processing system that includes processor circuitry and code-storing memory circuitry, the processing system configured to cause the device to perform the method of one or more of Aspects 1-41.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a first network entity, a set of rules associated with a steering mode for access network (AN) selection in accordance with an energy usage metric and a quality of service (QoS) metric associated with communication with a second network entity via at least one AN;
transmit, via the at least one AN selected in accordance with the set of rules, an uplink communication to the second network entity; and
receive, via the at least one AN selected in accordance with the set of rules, a downlink communication from the second network entity.

2. The UE of claim 1, wherein the first network entity is a session management function (SMF) and the second network entity is a user plane function (UPF).

3. The UE of claim 1, wherein the processing system is configured to cause the UE to:
measure or estimate the energy usage metric or the QoS metric in accordance with the one or more rules associated with the steering mode;
compare the energy usage metric to an energy threshold or the QoS metric to a quality threshold; and
select the at least one AN in accordance with the energy usage metric satisfying the energy threshold or the QoS metric satisfying the quality threshold,
wherein the energy usage metric or the QoS metric are associated with one or more of the uplink communication or the downlink communication.

4. The UE of claim 3, wherein the processing system is configured to cause the UE to receive, from the first network entity, an indication or configuration for the energy threshold or the quality threshold.

5. The UE of claim 1, wherein the one or more rules associated with the steering mode include a schedule for applying one of the energy usage metric or the QoS metric for AN selection.

6. The UE of claim 1, wherein the one or more rules associated with the steering mode include one or more rules associated with a first time window for applying the energy usage metric and a second time window for applying the QoS metric.

7. The UE of claim 1, wherein the one or more rules associated with the steering mode include one or more rules for applying the energy usage metric for a first percentage of time and for applying the QoS metric for a second percentage of time.

8. The UE of claim 1, wherein the processing system is configured to cause the UE to receive, from the first network entity, a primary entity indication indicating one of the UE or the second network entity as a primary entity for choosing criteria for selecting the at least one AN for communication between the UE and the second network entity.

9. The UE of claim 1, wherein the processing system is configured to cause the UE to transmit a criteria selection indication to the second network entity.

10. The UE of claim 1, wherein the processing system is configured to cause the UE to receive, from the second network entity, a criteria preference indication.

11. The UE of claim 10, wherein the set of rules for the steering mode include one or more rules for selecting the AN in accordance with the criteria preference indication of the second network entity.

12. The UE of claim 10, wherein the processing system is configured to cause the UE to transmit, to the second network entity, an approval indication or a disapproval indication associated with the criteria preference indication of the second network entity.

13. The UE of claim 1, wherein the processing system is configured to cause the UE to receive a criteria selection indication from the second network entity.

14. The UE of claim 1, wherein the processing system is configured to cause the UE to transmit, to the second network entity, a criteria preference indication.

15. The UE of claim 14, wherein the processing system is configured to cause the UE to receive, from the second network entity, an approval indication or a disapproval indication associated with the criteria preference indication.

16. A user plane function (UPF), comprising:
a processing system that includes one or more processors and one or more code-storing memories coupled with the one or more processors, the processing system configured to cause the UPF to:
receive, from a network entity, a set of rules associated with a steering mode for access network (AN) selection in accordance with an energy usage metric and a quality of service (QoS) metric associated with communication with a user equipment (UE) via at least one AN;
receive, via the at least one selected AN in accordance with the set of rules, an uplink communication from the UE; and
transmit, via the at least one selected AN in accordance with the set of rules, a downlink communication to the UE.

17. The UPF of claim 16, wherein the network entity is a session management function.

18. The UPF of claim 16, wherein the processing system is configured to cause the UPF to:
measure or estimate the energy usage metric or the QoS metric in accordance with the one or more rules associated with the steering mode;
compare the energy usage metric to an energy threshold or the QoS metric to a quality threshold; and
select the at least one AN in accordance with the energy usage metric satisfying the energy threshold or the QoS metric satisfying the quality threshold,
wherein the energy usage metric and the QoS metric are associated with one or more of the uplink communication or the downlink communication.

19. The UPF of claim 18, wherein the processing system is configured to cause the UPF to receive, from the network entity, an indication or configuration for the energy threshold.

20. The UPF of claim 16, wherein the one or more rules associated with the steering mode include a schedule for applying one of the energy usage metric or the QoS metric for AN selection.

21. The UPF of claim 16, wherein the one or more rules associated with the steering mode include one or more rules associated with a first time window for applying the energy usage metric and a second time window for applying the QoS metric.

22. The UPF of claim 16, wherein the one or more rules associated with the steering mode include one or more rules for applying the energy usage metric for a first percentage of time and for applying the QoS metric for a second percentage of time.

23. The UPF of claim 16, wherein the processing system is configured to cause the UPF to receive, from the network entity, a primary entity indication indicating one of the UE or the UPF as a primary entity for selecting criteria for the steering mode.

24. The UPF of claim 16, wherein the processing system is configured to cause the UPF to transmit a criteria selection indication to the UE.

25. The UPF of claim 16, wherein the processing system is configured to cause the UPF to receive, from the UE, a criteria preference indication.

26. The UPF of claim 16, wherein the processing system is configured to cause the UPF to receive a criteria selection indication from the UE.

27. The UPF of claim 16, wherein the processing system is configured to cause the UPF to transmit, to the UE, a criteria preference indication.

28. A session management function (SMF), comprising:
a processing system that includes one or more processors and one or more code-storing memories coupled with the one or more processors, the processing system configured to cause the SMF to:
transmit, to a user equipment (UE), a first set of rules associated with a steering mode for access network (AN) selection in accordance with an energy usage metric and a quality of service (QoS) metric; and
transmit, to a network entity, a second set of rules associated with the steering mode for AN selection in accordance with the energy usage metric and the QoS metric.

29. The SMF of claim 28, wherein the network entity is a user plane function.

30. A method of wireless communication performed by a user equipment (UE), comprising:
receiving, from a first network entity, a set of rules associated with a steering mode for access network (AN) selection in accordance with an energy usage metric and a quality of service (QoS) metric associated with communication with a second network entity via at least one AN;
transmitting, via the at least one AN selected in accordance with the set of rules, an uplink communication to the second network entity; and
receiving, via the at least one AN selected in accordance with the set of rules, a downlink communication from the second network entity.
